(19) United States
(12) Patent Application Publication
(10) Pub. No.: US 2013/0122190 A1
(43) Pub. Date: May 16, 2013

(54) CHEMICAL BATH DEPOSITION SYSTEM AND RELATED CHEMICAL BATH DEPOSITION METHOD

(71) Applicants: Shih-Wei Lee, Kaohsiung City (TW); Lung-Chieh Wang, Taichung City (TW)

(72) Inventors: Shih-Wei Lee, Kaohsiung City (TW); Lung-Chieh Wang, Taichung City (TW)

(21) Appl. No.: 13/456,208

(22) Filed: Apr. 25, 2012

(30) Foreign Application Priority Data
Nov. 10, 2011 (TW) 100141019

(51) Int. Cl. B05D 1/18; B05C 3/09

(52) U.S. Cl. 427/74; 118/400; 118/72

(57) ABSTRACT

A chemical bath deposition system is used for forming a buffer layer and a ZnO window layer on a back electrode substrate having a photoelectric transducing layer. The chemical bath deposition system includes a first bath tank and a second bath tank. The first bath tank is used for storing a buffer-layer solution. The buffer-layer solution forms the buffer layer on the photoelectric transducing layer when the back electrode substrate is immersed in the buffer-layer solution. The second bath tank is for storing a window-layer solution. The window-layer solution forms the ZnO window layer on the buffer layer when the back electrode substrate is immersed in the window-layer solution. The first bath tank and the second bath tank are in an in-line arrangement.

### BACKGROUND OF THE INVENTION

1. Field of the Invention

The present invention relates to a chemical bath deposition system and a related chemical bath deposition method, and more specifically, to a chemical bath deposition system utilizing a first bath tank and a second bath tank to sequentially form a buffer layer and a ZnO window layer on a back electrode substrate and a related chemical bath deposition method.

2. Description of the Prior Art

In a conventional solar battery manufacturing process, a common design of forming a ZnO window layer and a buffer layer on a photoelectric transducing layer of a back electrode substrate involves utilizing a chemical bath deposition apparatus to form the buffer layer (e.g. CdS or ZnS) on the photoelectric transducing layer first and then utilizing a sputtering machine to form the ZnO window layer on the buffer layer. However, besides a water cleaning process, a dry process is also needed to perform on the back electrode substrate after the buffer layer is formed, for preventing the subsequent vacuum process of the sputtering machine from being influenced. Furthermore, since dust may heap on the buffer layer during the period of transporting the back electrode substrate with the buffer layer to the sputtering machine for performing a ZnO window layer forming process, the forming quality of the solar battery may be influenced. In summary, the prior art design, in which the chemical bath deposition apparatus and the sputtering machine are not in the same product line, may not only increase the process time of the solar battery, but also cause dust accumulation on the back electrode substrate.

In addition, besides the drawback that it is necessary to dispose two different forming apparatuses in the prior art design so as to cause a high manufacturing cost, the prior art design may also cause decrease of equipment utilization due to regular maintenance and target replacement of the sputtering machine so as to influence the productive capacity of the solar battery. Thus, how to reduce the process time and equipment cost of the solar battery manufacturing process in forming the buffer layer and ZnO window layer is an important issue of the solar industry.

### SUMMARY OF THE INVENTION

The present invention provides a chemical bath deposition system for forming a buffer layer and a ZnO window layer on at least one back electrode substrate having a photoelectric transducing layer. The chemical bath deposition system includes a first bath tank and a second bath tank. The first bath tank is for storing a buffer-layer solution. The buffer-layer solution forms the buffer layer on the photoelectric transducing layer when the back electrode substrate is placed in the first bath tank to be immersed in the buffer-layer solution. The second bath tank is for storing a window-layer solution. The window-layer solution forms the ZnO window layer on the buffer layer when the back electrode substrate is placed in the second bath tank to be immersed in the window-layer solution. The first bath tank and the second bath tank are in an in-line arrangement.

The present invention further provides a chemical bath deposition method for forming a buffer layer and a ZnO window layer on at least one back electrode substrate having a photoelectric transducing layer. The chemical bath deposition method includes immersing the back electrode substrate in a buffer-layer solution of a first bath tank to form the buffer layer on the photoelectric transducing layer, taking the back electrode substrate out of the first bath tank, and immersing the back electrode substrate in a window-layer solution of a second bath tank to form the ZnO window layer on the buffer layer. The first bath tank and the second bath tank are in an in-line arrangement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a chemical bath deposition system according to an embodiment of the present invention.

FIG. 2 is a flowchart of a chemical bath deposition method for utilizing the chemical bath deposition system in FIG. 1 to form a buffer layer and a ZnO window layer on a back electrode substrate having a photoelectric transducing layer.

### DETAILED DESCRIPTION

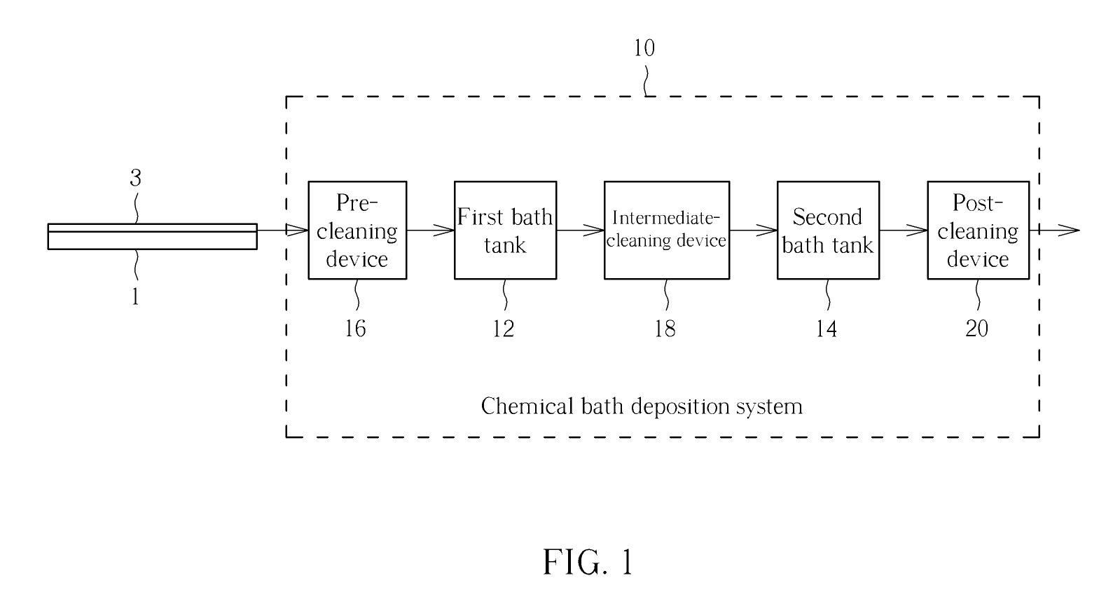

Please refer to FIG. 1, which is a functional block diagram of a chemical bath deposition system 10 according to an embodiment of the present invention. The chemical bath deposition system 10 is used for forming a buffer layer and a ZnO window layer on a photoelectric transducing layer 3 of at least one back electrode substrate 1 (one shown in FIG. 1) sequentially. The design of forming the back electrode substrate 1 and the photoelectric transducing layer 3 is commonly seen in the prior art. In brief, the substrate of the back electrode substrate 1 could be a soda-lime glass, and the back electrode layer of the back electrode substrate 1 could be made of molybdenum (Mo) material, Tantalum (Ta) material, Titanium (Ti) material, Vanadium (V) material, or Zirconium (Zr) material. The photoelectric transducing layer 3 could be made of copper indium gallium selenide (CIGS), but not limited thereto. That is, the back electrode substrate 1 and the photoelectric transducing layer 3 could also be made of other material commonly applied to a solar battery. To be noted, the present invention could also form a buffer layer and a ZnO window layer on plural back electrode substrates respectively in a batch manner for further increasing the productive capacity of the chemical bath deposition system 10.

As shown in FIG. 1, the chemical bath deposition system 10 includes a first bath tank 12 and a second bath tank 14. The first bath tank 12 is used for storing a buffer-layer solution. The buffer-layer solution is used for forming a buffer layer on the photoelectric transducing layer 3. The buffer layer is made of a cation and an anion. The cation is selected from at least one of a zinc ion, a cadmium ion, a mercury ion, an aluminum ion, a gallium ion, and an indium ion, and the anion is selected from at least one of an oxygen ion, a sulfur ion, a selenium ion, and a hydroxide ion. For example, the buffer layer could be made of cadmium sulfide (CdS), zinc sulfide (ZnS), cadmium zinc sulfide (CdZnS) or indium sulfide (In₂S₃). The first bath tank 12 and the second bath tank 14 could be in an in-line arrangement, meaning that the second bath tank 14 is adjacent to the first bath tank 12 and is located in the same product line with the first bath tank 12. In such a manner, once the buffer-layer forming process is completed, the window-layer forming process could be immediately performed on the back electrode substrate 1. The second bath tank 14 is used for storing a window-layer solution. In general, the window-layer solution could include a hydrogen dioxide solution, an ammonia solution, and a zinc-ion solution (e.g. a zinc sulfate (ZnSO₄) solution, a zinc acetate (Zn (CH₃COO)₂.2H₂O) solution, or a Zinc chloride (ZnCl₂) solution). The window-layer solution is used for forming a ZnO window layer on the buffer layer.

Furthermore, for improving the forming quality of the buffer layer and the ZnO window layer, as shown in FIG. 1, the chemical bath deposition system 10 could further include a pre-cleaning device 16, an intermediate-cleaning device 18, and a post-cleaning device 20. The pre-cleaning device 16 is used for cleaning the back electrode substrate 1 before the back electrode substrate 1 is placed in the first bath tank 12. The intermediate-cleaning device 18 is used for cleaning the back electrode substrate 1 before the back electrode substrate 1 is placed in the second bath tank 14. The post-cleaning device 20 is used for cleaning the back electrode substrate 1 after the back electrode substrate 1 is displaced from the second bath tank 14. In such a manner, via the aforesaid design of cleaning the back electrode substrate 1 before and after the buffer layer is formed and after the ZnO window layer is formed, the chemical bath deposition system 10 could further improve the forming quality of the buffer layer and the ZnO window layer and prevent dust from heaping on the back electrode substrate 1.

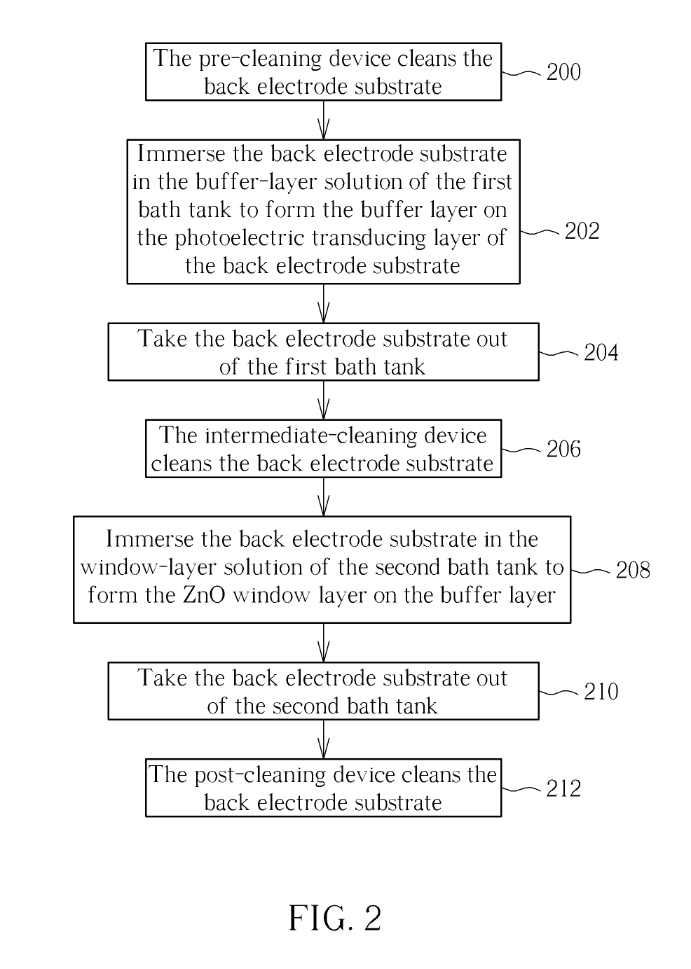

Next, please refer to FIG. 2, which is a flowchart of a chemical bath deposition method for utilizing the chemical bath deposition system 10 in FIG. 1 to form the buffer layer and the ZnO window layer on the back electrode substrate 1 having the photoelectric transducing layer 3. The chemical bath deposition method includes the following steps.

Step 200: The pre-cleaning device 16 cleans the back electrode substrate 1;

Step 202: Immerse the back electrode substrate 1 in the buffer-layer solution of the first bath tank 12 to form the buffer layer on the photoelectric transducing layer 3 of the back electrode substrate 1;

Step 204: Take the back electrode substrate 1 out of the first bath tank 12;

Step 206: The intermediate-cleaning device 18 cleans the back electrode substrate 1;

Step 208: Immerse the back electrode substrate 1 in the window-layer solution of the second bath tank 14 to form the ZnO window layer on the buffer layer;

Step 210: Take the back electrode substrate 1 out of the second bath tank 14;

Step 212: The post-cleaning device 20 cleans the back electrode substrate 1.

More detailed description for the aforesaid steps is provided as follows. After the process of forming the back electrode substrate 1 having the photoelectric transducing layer 3 is completed, the pre-cleaning device 16 could be utilized to clean the back electrode substrate 1 (Step 200) for preventing dust from heaping on the photoelectric transducing layer 3. As for the process of forming the back electrode substrate 1 and the photoelectric transducing layer 3, it is commonly seen in the prior art. In brief, a sputtering machine or other electrode forming technology is utilized to form a back electrode layer on a substrate of the back electrode substrate 1, and a thin-film deposition technology or other thin-film forming technology is then utilized to form the photoelectric transducing layer 3 on the back electrode substrate 1.

Subsequently, the cleaned back electrode substrate 1 could be immersed in the buffer-layer solution of the first bath tank 12 (Step 202). At this time, the buffer layer could be formed accordingly and distributed uniformly on the photoelectric transducing layer 3 of the back electrode substrate 1.

After the buffer layer is formed, the back electrode substrate 1 could be taken out of the first bath tank 12 (Step 204), and then the intermediate-cleaning device 18 could be utilized to clean the back electrode substrate 1 having the buffer layer formed thereon (Step 206), so as to prevent dust from heaping on the buffer layer.

Next, the cleaned back electrode substrate 1 could be immersed in the window-layer solution of the second bath tank 14 (Step 208). At this time, the ZnO window layer could be formed accordingly and distributed uniformly on the buffer layer of the back electrode substrate 1.

Finally, the back electrode substrate 1 could be taken out of the second bath tank 14 (Step 210), and then the post-cleaning device 20 could be utilized to clean the back electrode substrate 1 having the ZnO window layer formed thereon (Step 212), so as to prevent dust from heaping on the ZnO window layer.

As mentioned in the aforesaid steps, the chemical bath deposition system of the present invention utilizes the design in which the back electrode substrate having the photoelectric transducing layer is immersed in the first bath tank and the second bath tank in turn to sequentially form the buffer layer and the ZnO window layer on the photoelectric transducing layer, for replacing the prior art design in which a sputtering machine is additionally needed to form the ZnO window layer on the buffer layer. Plus, in the present invention, the first bath tank and the second bath tank are in an in-line arrangement. In such a manner, since a sputtering machine could be omitted and there is no need to take a back electrode substrate out of a chemical bath apparatus for being transported to a sputtering machine, the present invention could not only prevent decrease of equipment utilization so as to improve the productive capacity of the solar battery manufacturing process, but also efficiently reduce the equipment cost and process time of the solar battery manufacturing process in forming the buffer layer and ZnO window layer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A chemical bath deposition system for forming a buffer layer and a ZnO window layer on at least one back electrode substrate having a photoelectric transducing layer, the chemical bath deposition system comprising:
a first bath tank for storing a buffer-layer solution, the buffer-layer solution forming the buffer layer on the photoelectric transducing layer when the back electrode substrate is placed in the first bath tank to be immersed in the buffer-layer solution; and
a second bath tank for storing a window-layer solution, the window-layer solution forming the ZnO window layer on the buffer layer when the back electrode substrate is placed in the second bath tank to be immersed in the window-layer solution;
wherein the first bath tank and the second bath tank are in an in-line arrangement.

2. The chemical bath deposition system of claim 1, wherein the buffer layer is made of a cation and a anion, the cation is selected from at least one of a zinc ion, a cadmium ion, a mercury ion, an aluminum ion, a gallium ion, and an indium ion, and the anion is selected from at least one of an oxygen ion, a sulfur ion, a selenium ion, and a hydroxide ion.

3. The chemical bath deposition system of claim 1, wherein the window-layer solution comprises a hydrogen dioxide solution, an ammonia solution, and a zinc-ion solution.

4. The chemical bath deposition system of claim 1 further comprising:
a pre-cleaning device for cleaning the back electrode substrate before the back electrode substrate is placed in the first bath tank;
an intermediate-cleaning device for cleaning the back electrode substrate before the back electrode substrate is placed in the second bath tank; and
a post-cleaning device for cleaning the back electrode substrate after the back electrode substrate is displaced from the second bath tank.

5. A chemical bath deposition method for forming a buffer layer and a ZnO window layer on at least one back electrode substrate having a photoelectric transducing layer, the chemical bath deposition method comprising:
immersing the back electrode substrate in a buffer-layer solution of a first bath tank to form the buffer layer on the photoelectric transducing layer;
taking the back electrode substrate out of the first bath tank; and
immersing the back electrode substrate in a window-layer solution of a second bath tank to form the ZnO window layer on the buffer layer;
wherein the first bath tank and the second bath tank are in an in-line arrangement.

6. The chemical bath deposition method of claim 5 further comprising:
cleaning the back electrode substrate before immersing the back electrode substrate in the buffer-layer solution of the first bath tank.

7. The chemical bath deposition method of claim 5 further comprising:
cleaning the back electrode substrate before immersing the back electrode substrate in the window-layer solution of the second bath tank.

8. The chemical bath deposition method of claim 5 further comprising:
taking the back electrode substrate out of the second bath tank; and
cleaning the back electrode substrate.
